(19) United States
(12) Patent Application Publication
(10) Pub. No.: US 2020/0282845 A1
(43) Pub. Date: Sep. 10, 2020

(54) VEHICLE BATTERY HOUSING

(71) Applicant: Ford Global Technologies, LLC, Dearborn, MI (US)

(72) Inventors: Marius Sawatzki, Pulheim (DE); Daniel Meckenstock, Wuppertal (DE)

(73) Assignee: Ford Global Technologies, LLC, Dearborn, MI (US)

(21) Appl. No.: 16/806,599

(22) Filed: Mar. 2, 2020

(30) Foreign Application Priority Data
Mar. 6, 2019 (DE) 102019203046.7

(51) Int. Cl. B60L 50/64; B60K 1/04

(52) U.S. Cl. CPC B60L 50/64; B60K 2001/0422; B60K 1/04

(57) ABSTRACT

An assembly for a hybrid motor vehicle, in particular a partially electrified hybrid motor vehicle, includes a vehicle battery with a battery housing, and a vehicle seat with a seat face. The vehicle seat is connected or can be connected by means of at least two seat rails to a vehicle floor of the hybrid motor vehicle. The vehicle battery is arranged or capable of being arranged below the vehicle seat and above the vehicle floor, and, furthermore, the battery housing of the vehicle battery includes a deflection bevel which is arranged on the upper side or in an upper region of the vehicle battery and/or of the battery housing.

### CROSS-REFERENCE TO RELATED APPLICATIONS

This patent application claims priority to German Application No. 102019203046.7 filed Mar. 6, 2019, which is hereby incorporated herein by its reference in its entirety.

### BACKGROUND

A widespread variety of a hybrid motor vehicle is what is known as a mild hybrid. Although an electric motor is used in the case of what are known as partially electrified hybrid motor vehicles (“mild hybrid” or “mHEV”), the torque and battery performance of said electric motor is not sufficient to drive the motor vehicle on its own. The electric drive merely assists the internal combustion engine for increasing the performance, fully electric driving thus not being possible. Nevertheless, the mild hybrid has a satisfactory fuel saving potential and can additionally be integrated with a small amount of effort into existing vehicle concepts, whereas more development effort is required for full hybrids. The vehicle battery for mild hybrids of this type is typically embodied as a 48 volt battery.

The stowage space for the vehicle battery in a hybrid motor vehicle, in particular even for the 48 volt battery in a partially electrified hybrid motor vehicle, which stowage space is safe and at the same time practicable, is limited. A suitable place with sufficient stowage space is the region below the driver's seat between the seat rails.

One important aspect in the case of motor vehicles is the safety for the occupants in the case of accidents, which safety can be affected by the configuration and effectiveness of the existing deformation zone or crumple zone. An effective crumple zone serves, however, not only for the protection of the occupants against a direct mechanical action, but rather also for the protection of the vehicle electronics and, in the case of a hybrid vehicle, for the protection of the vehicle battery, as well. In the case of a lateral impact, there is the risk that the seat rails move in the vehicle transverse direction, come into contact with the housing of the vehicle battery and damage the vehicle battery. The safety of the driver and the vehicle battery in the region of the driver's seat is typically tested by way of the side impact test. Here, a lateral collision is simulated, in the case of which the vehicle is thrown laterally against rigid objects such as trees or poles or against movable objects such as other vehicles.

Various solutions for protecting the driver and/or the vehicle battery in the case of a collision of the vehicle are proposed in the prior art.

In U.S. Pat. No. 9,579,963 B2, battery modules are arranged distributed over the entire vehicle below the vehicle floor. Here, in order to design the deformation zone, modules of a first type can be moved relative to one another in the case of an impact, whereas modules of a second type can be moved only together as a group. Here, the battery modules of the first type are arranged in a housing, the cross section of which is of trapezoidal configuration perpendicularly with respect to the vehicle vertical.

DE 10 2011 117 361 A1 relates to a reinforcement of the vehicle body floor with a battery module which lies below it. The additional reinforcement is intended to prevent a latching element which is present for dismantling the vehicle seat being released unintentionally in the case of any front and/or rear impact. Here, a tunnel-side seat rail drops obliquely toward the rear in the vehicle longitudinal direction, as a result of which additional stowage space for the battery module is provided below the driver's seat.

In U.S. Pat. No. 9,499,205 B 1, the tank and the vehicle battery of the vehicle are arranged in a region below the seat group in an exoskeleton comprising elongate rails and transverse struts. In the case of an impact of the vehicle, the exoskeleton is deformed in a predefined way and in the process protects the vehicle battery and the tank.

In order to forward the force in the case of a lateral impact toward the tunnel, a transverse strut is provided in EP 1 700 776 A1. It is intended to be prevented here that the transverse strut moves downward. For this purpose, on the underside, the transverse strut has a projection which supports the transverse strut and prevents a movement of the transverse strut in the downward direction.

In US 2014/0338997 A1, a vehicle battery is arranged partially below a crossmember for a vehicle seat. In order to protect the vehicle occupant and the vehicle battery in the case of a lateral impact, the crossmember and the vehicle floor which lies below it are configured with a beveled step. At the same time, the region of the step is of weakened configuration, with the result that the said region deflects in the case of a lateral impact. As a result, no stop region can be configured either between the crossmember and the vehicle battery in the case of a lateral impact; rather, the crossmember is deflected upward and slides past the vehicle battery.

DE 10 2011 119 540 A1 relates to a battery arrangement in a vehicle, in the case of which battery arrangement the vehicle battery is attached fixedly to the vehicle body below the vehicle seats. In the case of a lateral impact, a carrier structure which surrounds the vehicle battery is deformed, with the result that the carrier structure is moved in the vehicle transverse direction, whereas the vehicle battery remains in a stationary manner on the vehicle body in an unchanged state in a manner which is decoupled in terms of motion from the transverse movement.

DE 10 2010 045 997 A1 discloses an assembly, in the case of which a vehicle battery is arranged in the central tunnel of the vehicle in a trapezoidal manner, that is to say with lateral bevels. A likewise beveled reinforcement is provided on the upper side of the vehicle battery, as a result of which the vehicle battery is adapted together with the reinforcement to the geometry in the interior space in the central tunnel. Supported from the inside in this way, in the case of a lateral impact, the central tunnel forms a support or an abutment against a crossmember of the vehicle seat, which crossmember has a predetermined break point. As a result of the predetermined break point, the crossmember buckles upward and lifts or pushes the seat frame of the vehicle seat over the central tunnel.

In view of the indicated prior art, the safety of the vehicle battery in the case of vehicle collisions therefore still has room for improvements. Although struts and protective devices can protect the vehicle battery against direct mechanical action, additional components are necessary for these solutions, which also results in a higher vehicle weight. Solutions which are already known and in the case of which the seat rails are held at a constant spacing from one another are also to be retained.

### BRIEF DESCRIPTION OF THE DRAWINGS

FIG. 1b is a front view outline sketch of the exemplary vehicle seat and battery from the prior art during a lateral vehicle impact.

FIG. 2a shows a front view outline sketch of an exemplary vehicle seat and battery before a lateral vehicle impact.

FIG. 2b shows a front view outline sketch of an exemplary vehicle seat and battery during a lateral vehicle impact.

### DETAILED DESCRIPTION

The assembly described herein protects a vehicle battery of a hybrid motor vehicle and at the same time optimizes the deformation zone of the motor vehicle, in order to improve the occupant safety, in particular in the case of a lateral impact.

Protecting the vehicle battery is achieved by way of an assembly for a hybrid motor vehicle, having the vehicle battery, with a battery housing, and a vehicle seat. The vehicle battery is arranged or capable of being arranged below the vehicle seat and above the vehicle floor.

It is to be noted that the features and measures which are indicated individually in the following description can be combined with one another in any desired, technically appropriate way. The designations “above” and “below” or “on the upper side” and “on the lower side” are to be understood with regard to an operating position of the vehicle. The “vehicle longitudinal direction” or X-direction means a substantially horizontal direction along the vehicle longitudinal axis. The “vehicle transverse direction” or Y-direction means a substantially horizontal direction transversely with respect to the vehicle longitudinal axis. A “vehicle vertical direction” or Z-direction means a direction which is substantially perpendicular with respect to the underlying surface. The vehicle battery can be positioned below the driver's seat, but the vehicle battery can also be arranged below any other vehicle seat in the vehicle. Even if the term “battery housing” is usually used in a simplified manner, this term also includes the use of additional battery cages or protective cages on the battery housing.

An assembly for a hybrid motor vehicle, in particular a partially electrified hybrid motor vehicle, includes a vehicle battery with a battery housing, and a vehicle seat with a seat face. The vehicle seat is connected or capable of being connected by at least two seat rails to a vehicle floor of the hybrid motor vehicle, and the vehicle battery is arranged or capable of being arranged below the vehicle seat and above the vehicle floor. Furthermore, the battery housing of the vehicle battery includes a deflection bevel which is arranged on the upper side or in an upper region of the vehicle battery and/or the battery housing.

Damage of the vehicle battery and/or the battery housing by way of coming into contact with or impacting or abutting against one of the seat rails which is adjacent with respect to the vehicle battery can be avoided by way of the deflection bevel. Instead of impacting against a side wall of the battery housing, the seat rail would slide along the deflection bevel over the vehicle battery and/or the battery housing. In the case of a lateral impact of the vehicle (for example, barrier, post, other vehicle, etc.), corresponding kinetic energy would be transmitted to the seat rails of the vehicle seat in accordance with the prior art, whereupon the seat rails would be displaced in the direction of the central tunnel in the region of the vehicle longitudinal axis. Transverse reinforcements are possibly provided between the two seat rails which are adjacent with respect to the vehicle battery, which transverse reinforcements hold the seat rails at a fixed spacing from one another. In this case, the two rails would move at a fixed spacing and relative to the vehicle battery. A solution of this type would function for every type of vehicle; however, an additional component is then required, whereby the weight of the vehicle is increased. Without a spacer element device of this type, at least the seat rail which lies closer to the lateral impact would move toward the vehicle battery. No stop is formed, however, as a result of the deflection bevel in the region of the seat rail, which stop might lead, for example, to a deformation or damage of the battery housing. By way of the seat rail sliding on the battery, the structure can deform further and can dissipate kinetic energy, without the battery being damaged. The vehicle battery and the seat rail are displaced or nested inside one another. As a result of the integration of the deflection bevel into the battery housing, no additional components are necessary, whereby vehicle weight is saved and the parts complexity is decreased.

The battery housing can have a central tunnel region which faces a central tunnel of the motor vehicle and a sill region which faces a sill of the motor vehicle, and the deflection bevel for deflecting the seat rail can be arranged in the sill region.

The sill or door sill is situated in the region of a vehicle door. The central tunnel is typically arranged in a motor vehicle in the region of the vehicle longitudinal axis. The battery housing can be divided into a central tunnel region and into a sill region along an imaginary center plane. In the case of a lateral impact of a vehicle in the region of the vehicle seat, below which the vehicle battery is arranged, the sill region is usually considerably more susceptible to injury or damage than the central tunnel region. Therefore, the deflection bevel for protecting the vehicle battery can be arranged in the sill region, that is to say on that side of the battery housing which points toward the sill. The deflection bevel can of course also be arranged on that side of the battery housing which faces the central tunnel and/or even on its two sides. In every case, jamming of the battery between the seat rails is to be avoided. This can be achieved by way of sliding or pressing downward on in each case one side or even on both sides (central tunnel side/sill side) of the battery upper edge/edges. As an alternative or in addition, the deflection bevel for deflecting the seat rail or the seat rails is therefore also arranged in the central tunnel region. In this regard, a deflection bevel can in principle be used on every edge of the battery housing, whereby the vehicle battery can also be arranged below other vehicle seats. In particular, the vehicle battery and/or the battery housing can be rotated by 180°, whereby the same battery housing can be used for left hand drive (LHD) vehicles and right hand drive (RHD) vehicles.

An overlap between at least one of the seat rails and the battery housing with regard to a vehicle vertical can be at most 10 mm, in particular at most 5 mm.

As a result of the deflection bevel, an overlap between the vehicle battery and the adjacent seat rail can be tolerated with regard to the vehicle vertical or in the Z-direction. As a result, a larger battery unit can be realized in the battery protective space between the vehicle seat and the floor which lies below it. By way of this, as a consequence, larger battery modules and/or additional battery protective cages around the battery housing can be used. In the Z-direction, the overlap region can be at most 10 mm, in particular at most 5 mm or less. As a result, the deflection bevel can likewise be of comparatively small dimensions. Therefore, a design as a simple chamfer on the battery housing is conceivable, whereby the manufacture of the deflection bevel is simplified greatly.

The deflection bevel can enclose an inclination angle α of between 5° and 20° with an upper side of the battery housing, which upper side runs horizontally and/or in parallel with respect to the vehicle seat.

As a result of a flat gradient of this type, the normal force which acts by way of the seat rail on the battery housing perpendicularly on the surface of the battery housing during the sliding operation of the seat rail over the battery housing is very low. The effects of the load path on the battery housing are reduced greatly as a result. The smaller the inclination angle, the lower the normal force which acts on the battery housing. The greater the inclination angle, the greater admittedly the normal force which acts on the battery housing; however, a greater overlap between the battery housing and the seat rail can also be tolerated in this way. An inclination angle of between 5° and 20° represents an optimum range between said boundary conditions.

The inclination angle α can additionally advantageously be of constant configuration over the entire deflection bevel length of the deflection bevel.

A constant inclination angle over the entire length of the deflection bevel makes simple production on the battery housing possible. As an alternative, the deflection bevel on a complementary geometry of the adjacent seat rail can also be configured with an inclination angle which changes over the length of the deflection bevel. A change of this type of the inclination angle can be configured continuously with a transition or in a stepped manner.

In the case of a lateral impact of the hybrid motor vehicle, the seat rail can be moved by way of the deflection bevel along a first displacement direction in the upward direction, in the direction of the vehicle seat, and/or the battery housing can be moved along a second displacement direction in the downward direction, in the direction of the vehicle floor.

Together with the seat rail, the vehicle seat and the vehicle occupant who is situated on it can be moved upward. As a result, the kinetic energy of the impact is partially dissipated by the weight of the vehicle occupant and the vehicle seat being lifted. Accordingly, no kinetic energy is dissipated by the battery housing being loaded mechanically and being deformed in this way, but rather instead primarily by way of an increase of the free deformation region below the seat and, associated with this, by way of available structure deformation. As a result of the gradient of the deflection bevel, the battery drops merely slightly. The risk of damage of the battery housing by way of a vehicle floor which deflects as a consequence of the lateral impact is ruled out. As a result, the kinetic energy in the case of the vehicle impact is dissipated effectively and safely for the vehicle occupants and the vehicle battery.

The deflection bevel can extend along a longitudinal edge of the battery housing, the longitudinal edge of the battery housing running substantially parallel to the at least two seat rails.

By way of continuous configuration of the deflection bevel along the entire longitudinal edge of the battery housing or the vehicle battery, a rotation of the seat rail, and therefore of the vehicle seat, and the vehicle battery with respect to one another can be prevented. As an alternative, the deflection bevel is not configured over the complete longitudinal edge of the vehicle battery. In this case, a rotation which is possibly desired of the vehicle battery and the seat rail and/or the vehicle seat with respect to one another might be realized.

In addition, in order to slide off on the deflection bevel, at least one of the two seat rails can have a rounded or chamfered edge.

In order to reduce the friction between the seat rails and the battery housing while they are sliding past one another, the seat rail can also additionally have a device for facilitated deflection on the battery housing. That side edge of the seat rail which is provided for sliding on the deflection bevel of the vehicle battery might, for example, likewise be configured with a chamfered or rounded edge.

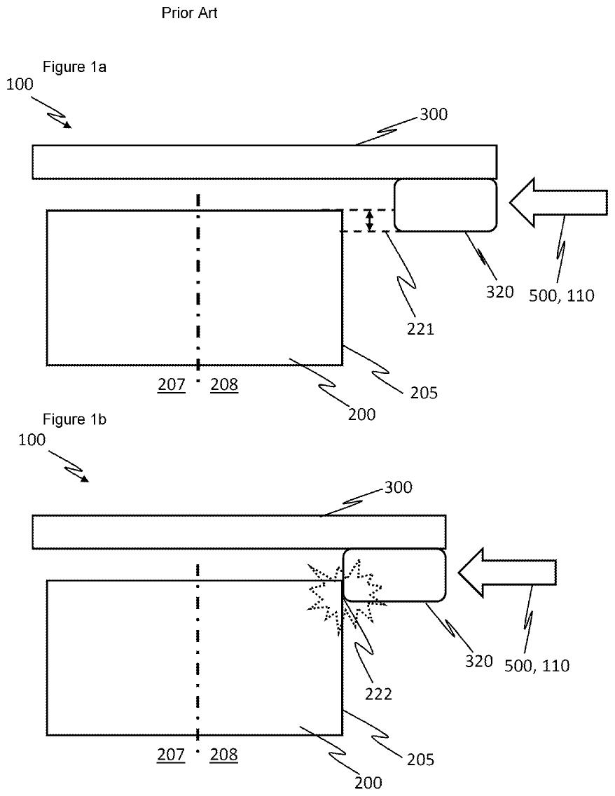

FIG. 1a is a front view outline sketch of an exemplary vehicle seat and battery from the prior art before a lateral vehicle impact.

In the different figures, identical parts are always provided with the same reference signs, for which reason they are also as a rule described only once. In particular, the figures are to be understood in such a way that various components are shown in a hidden or simplified manner for improved clarity. Even if the vehicle battery is shown in a cuboid shape in a simplified manner, it or the housing which surrounds it can have any suitable external form and optionally an additional battery cage/protective cage.

FIG. 1a shows an assembly 100 from the prior art with a vehicle battery 200 and a vehicle seat 300. Here, the vehicle seat 300 has two seat rails, only the sill-side seat rail 320 being depicted. The vehicle battery 200 is surrounded by a battery housing 205 which is shown in a cuboid shape in a simplified manner. The battery housing 205 can be divided into a central tunnel region 207 and into a sill region 208 along an imaginary center plane. In the case of a lateral impact 500 of a vehicle in the region of the vehicle seat 300, below which the vehicle battery 200 is arranged, the sill region 208 is usually considerably more susceptible to injury or damage than the central tunnel region 207, on account of the closeness to the impact 500. In order for the stowage space below the vehicle seat 300 to be utilized in as optimum a manner as possible, the vehicle battery 200 and the battery housing 205 which surrounds it are designed to be as large as possible for a large energy store volume. As a result, an overlap 221 between the battery housing 205 and the seat rail 320 is unavoidable with regard to the vehicle vertical direction or the Z-direction.

FIG. 1b shows a scenario, in the case of which the lateral impact 500 results in a load path 110 which has the consequence of an intrusion of the motor vehicle. As a result, the seat support 320 moves in the direction of the vehicle longitudinal axis or the central tunnel (not shown). As a consequence, a stop region 222 is configured at the overlap 221 (cf. FIG. 1a) in the sill region 208 of the battery housing 205. As a result, there is the danger that the battery housing 205 is damaged by way of the impact in the stop region 222.

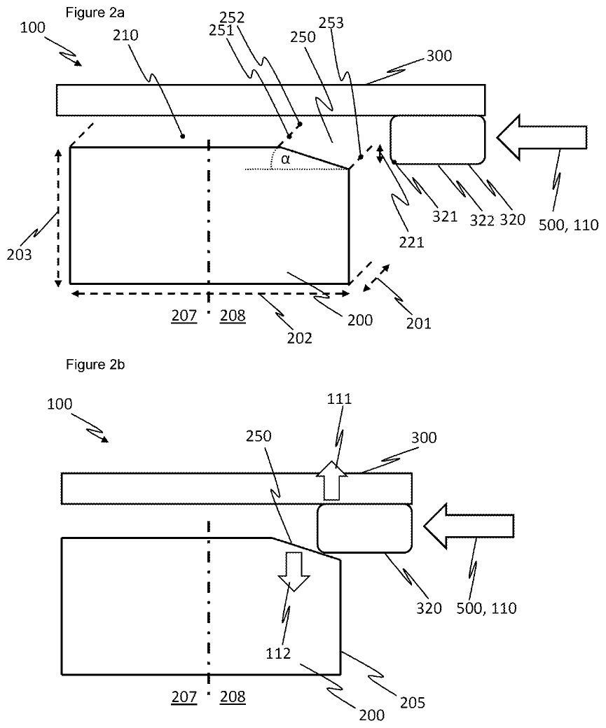

The outline sketch of FIG. 2a shows an assembly 100 for solving this problem, in the case of which assembly 100 the danger of injury of the vehicle battery 200 is reduced considerably. The substantially cuboid battery housing 205 has at least one longitudinal edge 201 along the vehicle longitudinal direction, at least one transverse edge 202 along the vehicle transverse direction, and at least one vertical edge 203 along the vehicle vertical direction. The extent of the battery housing 205 along the longitudinal edge 201 in the vehicle longitudinal direction is indicated by way of dashed lines. In the region of a longitudinal edge 201, the battery housing 205 is chamfered or beveled on an upper side 210 and in the sill region 208. Instead of a substantially right-angled transition between the upper side 210 and a side wall of the battery housing 205, a deflection bevel 250 is provided. Here, the deflection bevel 250 includes an inclination angle α of between 5° and 20° with the upper side 210 of the battery housing 205, which upper side 210 runs substantially horizontally and/or in parallel with respect to the vehicle seat 300. Furthermore, the deflection bevel 250 extends along the longitudinal edge 201 of the battery housing 205, the longitudinal edge 201 of the battery housing 205 running substantially parallel to the at least two seat rails 320. The deflection bevel 250 can extend along the entire length of the longitudinal edge 201 of the battery housing 205. In addition, the inclination angle α can advantageously be of constant configuration over the entire deflection bevel length 251 of the deflection bevel 250. Here, a seat rail lower side 322 of the seat rail 320 is arranged above a lower edge 253 of the deflection bevel 250 in the Z-direction. The deflection bevel 250 runs with a substantially planar wall with a gradient at an inclination angle α of between 5° and 20° as far as the upper edge 252 of the deflection bevel 250, with the result that the friction between the seat rail 320 and the deflection bevel 250 is low during sliding. The seat rail 320 can have a deflection device 321 in a boundary edge of the seat rail lower side 322 for improved sliding along the deflection bevel 250. Said deflection device 321 can be configured by the boundary edge having a curvature radius or being chamfered.

FIG. 2b shows a comparable scenario to that in FIG. 1b, in the case of which scenario the lateral impact 500 results in a load path 110 which has the consequence of an intrusion of the motor vehicle. In the case of a movement of the seat rail 320 in a vehicle transverse direction, the seat rail 320 comes into contact with the deflection bevel 250. Instead of the battery housing 205 being driven in the vehicle transverse direction by way of the configuration of a stop region 222 (cf. FIG. 1b), the battery housing 205 is pressed slightly downward in a displacement direction 112. At the same time, the seat rail 320 is displaced together with the vehicle seat 300 and the vehicle occupant who is seated thereon upward slightly in a displacement direction 111. In this way, an overlap 221 between the battery housing 205 and the seat rail 320 can be tolerated. Therefore, the stowage space or battery protective space between the vehicle seat 300 and the vehicle floor can be utilized in an improved manner by way of the capability for larger vehicle batteries 200 to be used, in particular vehicle batteries 200 with a greater overall height with regard to a vertical edge 203.

### LIST OF REFERENCE SIGNS

100 Assembly
110 Load path
111 Displacement direction, driver's seat
112 Displacement direction, vehicle battery
120 Movement direction
200 Vehicle battery
201 Longitudinal edge
202 Transverse edge
203 Vertical edge
205 Battery housing
207 Central tunnel region
208 Sill region
210 Upper side/upper region
221 Overlap
222 Stop region
250 Deflection bevel
251 Deflection bevel length
252 Upper edge of the deflection bevel
253 Lower edge of the deflection bevel
300 Vehicle seat
320 Seat rail
321 Deflection device/edge
322 Seat rail lower side
500 Lateral impact
α Inclination angle

1-8. (canceled)

9. An assembly for a hybrid motor vehicle comprising:
a vehicle floor;
a vehicle seat including a seat face and at least two seat rails, which vehicle seat is connected by the at least two seat rails to the vehicle floor; and
a vehicle battery including a battery housing;
wherein the vehicle battery is arranged below the vehicle seat and above the vehicle floor; and
the battery housing includes a deflection bevel which is arranged on an upper side or in an upper region of the battery housing.

10. The assembly of claim 9, wherein the battery housing includes a central tunnel region which faces a central tunnel of the motor vehicle and a sill region which faces a sill of the motor vehicle, and the deflection bevel is arranged in the sill region.

11. The assembly of claim 9, wherein an overlap between at least one of the seat rails and the battery housing with regard to a vehicle vertical direction is at most 10 mm.

12. The assembly of claim 9, wherein the battery housing includes an upper side running horizontally, and the deflection bevel encloses an inclination angle α of between 5° and 20° with an upper side of the battery housing.

13. The assembly of claim 12, wherein the inclination angle α is of constant configuration over an entire deflection bevel length of the deflection bevel.

14. The assembly of claim 9, wherein, in the case of a lateral impact of the hybrid motor vehicle tending to move a first seat rail of the seat rails laterally toward the vehicle battery, at least one of the following occurs: (1) the first seat rail is moved by way of the deflection bevel along a first displacement direction in the upward direction or (2) the battery housing is moved along a second displacement direction in the downward direction.

15. The assembly of claim 9, wherein the deflection bevel extends along a longitudinal edge of the battery housing, the longitudinal edge of the battery housing running substantially parallel to the at least two seat rails.

16. The assembly of claim 9, wherein at least one of the two seat rails has an edge that is one of rounded or chamfered.
